(19) United States
(12) Patent Application Publication
(10) Pub. No.: US 2006/0003210 A1
(43) Pub. Date: Jan. 5, 2006

(54) Solid polymer electrolyte membranes

(76) Inventors: David Ofer, Needham, MA (US); Bindu R. Nair, Framingham, MA (US); Robert F. Kovar, Wrentham, MA (US); Emily J. Stoler, Somerville, MA (US); Carlos C. Pascoal, Weymouth, MA (US); John D. Larouco, Milford, MA (US); William A. Stevenson, Concord, MA (US); Leslie S. Rubin, Newton, MA (US)

Correspondence Address: EDWARDS & ANGELL, LLP, P.O. BOX 55874, BOSTON, MA, 02205, US

(21) Appl. No.: 11/134,110

(22) Filed: May 20, 2005

Related U.S. Application Data
(60) Provisional application No. 60/573,154, filed on May 22, 2004.

(51) Int. Cl. H01M 8/10; C08J 5/22

(52) U.S. Cl. 429/30; 521/27; 429/33

(57) ABSTRACT

The present invention relates to solid polymer electrolyte membranes (SPEMs) which include a co-processed mixture of a substrate polymer and an ion-conducting material membrane, or more preferably include a membrane comprising a polymer blend of a substrate polymer and an ion-conducting material. SPEMs of the present invention are useful in electrochemical applications, including fuel cells.

### STATEMENT OF GOVERNMENT RIGHTS

This invention was made with Government support under Contract No.65112-001-03 3D awarded by the Department of Energy. The Government has certain rights in this invention.

### FIELD OF THE INVENTION

This invention relates to novel solid polymer electrolyte membranes (SPEMs), which comprise a co-processed mixture of a substrate polymer and an ion-conducting material, and use of same in electrochemical applications. Methods for producing the membranes of the invention are also disclosed.

### BACKGROUND OF THE INVENTION

There is a considerable need in both the military and commercial sectors for quiet, efficient and lightweight power sources that have improved power density. Military applications include, but are not limited to, submersibles, surface ships, portable/mobile field generating units, and low power units (i.e., battery replacements). For example, the military has a strong interest in developing low range power sources (a few watts to a few kilowatts) that can function as replacements for batteries. Commercial applications include transportation (i.e., automotive, bus, truck and railway), communications, on-site cogeneration and stationary power generation.

Other interest exists for household applications, such as radios, camcorders and laptop computers. Additional interest exists in larger power sources or sources of higher power density that can be used in operating clean, efficient vehicles. In general, there is a need for quiet, efficient and lightweight power sources anywhere stationary power generation is needed.

Additionally, the use of gasoline-powered internal combustion engines has created several environmental, exhaust gas-related problems. One possible solution to these environmental problems is the use of fuel cells. Fuel cells are highly efficient electrochemical energy conversion devices that directly convert the chemical energy derived from renewable fuel into electrical energy.

Significant research and development activity has focused on the development of proton-exchange membrane fuel cells. Proton-exchange membrane fuel cells have a polymer electrolyte membrane disposed between a positive electrode (cathode) and a negative electrode (anode). The polymer electrolyte membrane is composed of an ion-exchange polymer (i.e., ionomer). Its role is to provide a means for ionic transport and prevent mixing of the molecular forms of the fuel and the oxidant.

Solid polymer electrolyte fuel cells (SPEFCs) are an ideal source of quiet, efficient, and lightweight power. While batteries have reactants contained within their structure which eventually are used up, fuel cells use air and hydrogen to operate continuously. Their fuel efficiency is high (45 to 50 percent), they do not produce noise, operate over a wide power range (10 watts to several hundred kilowatts), and are relatively simple to design, manufacture and operate. Further, SPEFCs currently have the highest power density of all fuel cell types. In addition, SPEFCs do not produce any environmentally hazardous emissions such as NOₓ and SOₓ (typical combustion by-products).

The traditional SPEFC contains a solid polymer ion-exchange membrane that lies between two gas diffusion electrodes, an anode and a cathode, each commonly containing a metal catalyst supported by an electrically conductive material. The gas diffusion electrodes are exposed to the respective reactant gases, the reductant gas and the oxidant gas. An electrochemical reaction occurs at each of the two junctions (three phase boundaries) where one of the electrodes, electrolyte polymer membrane and reactant gas interface.

Despite their potential for many applications, SPEFCs have not yet been commercialized due to unresolved technical problems and high overall cost. One major deficiency impacting the commercialization of the SPEFC is the inherent limitations of today's leading membrane and electrode assemblies. To make the SPEFC commercially viable (especially in automotive applications), the membranes employed must operate at elevated/high temperatures (>120° C.) so as to provide increased power density, and limit catalyst sensitivity to fuel impurities. This would also allow for applications such as on-site cogeneration (high quality waste heat in addition to electrical power). Current membranes also allow excessive methanol crossover in liquid feed direct methanol fuel cells (dependent on actual operating conditions, but is typically equivalent to a current density loss of about 50 to 200 mA/cm² @ 0.5V). This crossover results in poor fuel efficiency as well as limited performance levels.

Several polymer electrolyte membranes have been developed over the years for application as solid polymer electrolytes in fuel cells. However, these membranes have significant limitations when applied to liquid-feed direct methanol fuel cells and to hydrogen fuel cells. The membranes in today's most advanced SPEFCs do not possess the required combination of ionic conductivity, mechanical strength, dehydration resistance, chemical stability and fuel impermeability (e.g., methanol crossover) to operate at elevated temperatures.

DuPont developed a series of perfluorinated sulfonic acid membranes known as Nafion® membranes. The Nafion® membrane technology is well known in the art and is described in U.S. Pat. Nos. 3,282,875 and 4,330,654. Unreinforced Nafion® membranes are used almost exclusively as the ion exchange membrane in present SPEFC applications. This membrane is fabricated from a copolymer of tetrafluoroethylene (TFE) and a perfluorovinyl ethersulfonyl fluoride. The vinyl ether comonomer is copolymerized with TFE to form a melt-processable polymer. Once in the desired shape, the sulfonyl fluoride group is hydrolyzed into the ionic sulfonate form.

There are several mechanisms that limit the performance of Nafion® membranes in fuel cell environments at temperatures above 100° C. In fact, these phenomena may begin at temperatures above even 80° C. Mechanisms include membrane dehydration, reduction of ionic conductivity, radical formation in the membrane (which can destroy the solid polymer electrolyte membrane chemically), loss of mechanical strength via softening, and increased parasitic losses through high fuel permeation.

In an effort to reduce costs and move toward potential commercialization of SPEFCs, ion-exchange membranes that are less expensive to produce also have been investigated for use in polymer electrolyte membrane fuel cells.

Sulfonated poly(aryl ether ketones) developed by Hoechst AG are described in European Patent No. 574,891,A2. These polymers can be crosslinked by primary and secondary amines. However, when used as membranes and tested in polymer electrolyte membrane fuel cells, only modest cell performance is observed.

Sulfonated polyaromatic based systems, such as those described in U.S. Pat. Nos. 3,528,858 and 3,226,361, also have been investigated as membrane materials for SPEFCs. However, these materials suffer from poor chemical resistance and mechanical properties that limit their use in SPEFC applications.

Solid polymer membranes comprising a sulfonated poly(2,6dimethyl1,4phenylene oxide) alone or blended with poly(vinylidene fluoride) also have been investigated. These membranes are disclosed in WO 97/24777. However, these membranes are known to be especially vulnerable to degradation from peroxide radicals.

The inherent problems and limitations of using solid polymer electrolyte membranes in electrochemical applications, such as fuel cells, at elevated/high temperatures (>100° C.) have not been solved by the polymer electrolyte membranes known in the art. Specifically, maintaining high ion conductivity and high mechanical strength, resisting dehydration and other forms of degradation remain problematic, especially at elevated operating temperatures. As a result, commercialization of SPEFCs has not been realized.

Celanese Ventures and Plug Power are commercializing a high temperature membrane that can operate at reduced relative humidities. These membranes comprise a substrate polymer such as polybenzimidazole doped with phosphoric acid. These membranes show good high temperature/low relative humidity performance but are limited by their lack of performance at low temperature and high relative humidity conditions. Thus, these membranes are not suitable for applications where load and temperature cycling, in part because temperature/relative humidity fluctuations may degrade the performance of the membrane. A membrane that operates over a wide range of temperatures and relative humidities is a goal that has not yet been met.

Composite polymer membranes having an ion conducting material dispersed in a microporous substrate polymer have been the subject of substantial research. Several membranes are disclosed in, U.S. Pat. No. 6,248,469 in which an ion conducting membrane is incorporated into pores of a microporous membrane composed of a rigid rod or extended rod lyotropic liquid crystalline polymer. Microporous membranes were traditionally prepared from as-polymerized dope solutions in part because the no methods had previously been disclosed to prepare lower concentration dope solutions of high molecular weight lyotropic liquid crystalline polymers by either lower concentration polymerization or by dilution of a high concentration dope.

Lyotropic liquid crystal polymers such as polyphenylene benzobisoxazole (PBO) and polyphenylene benzobisthiazole (PBZT) can be formed into fibers that exhibit the highest tensile strength of any polymeric fiber (>500 ksi) These so-called “rigid rod” polymers when spun into fibers, coagulated and dried also exhibit excellent high temperature capability (up to 550° C.) and excellent resistance to organic solvents and most common acids. The spin dopes of these materials are supplied as high molecular weight (intrinsic viscosity >24 dL/g) nematic phase solutions of the polymer in polyphosphoric acid (PPA). The typical spin dope contains 12-15% polymer by weight.

High strength biaxially oriented thin films of these materials have been recited in U.S. Pat. Nos. 4,963,428, 4,973,442, and 6,132,668 issued to Foster-Miller, Inc., which films are prepared using a modified blown film extrusion process using a novel counter-rotating circular die to impart shear orientation to the nematic phase polymer. It has also been demonstrated that these biaxially oriented films when coagulated in water or some other non-solvent can form extremely strong open membranes when preserved in the wet, swollen state. Using solvent exchange techniques it has been shown that a number of different materials such as sol gel glasses, polymers, including ion conducting polymers, and other materials etc. can be infused or imbibed into this membrane structure. When dried, the liquid crystal polymer network shrinks ( consolidates) around the imbibed material forming a very high strength structure that preserves the functional properties of the imbibed material.

U.S. Pat. No. 6,248,469 recites composite membranes and various methods of making same wherein ion conducting polymers (ICPS) are incorporated into the microporous PBO structure to produce a microcomposite proton exchange membrane (PEM) that would overcome the cost/performance problems of perfluorinated PEMs based on Dupont's Nafion polymer. Nafion type solid polymer electrolyte membranes exhibit long term stability of >20,000 hrs but cannot meet the needs for an automotive fuel cell due to high cost and serious degradation of mechanical strength at operating temperatures of greater than 100° C. The '469 patent recited various composite membranes having a relatively low cost sulfonated aromatic polymers, such as sulfonated polyether sulfones or sulfide/sulfones, imbibed into an appropriate PBO membrane support structure. These lower cost aromatic ion conductors address the PEM cost problem and the PBO support structure addresses the mechanical strength issues, permitting fuel cell operation at optimally efficient temperatures between 100 to 150° C. These higher operating temperatures improve fuel cell efficiency, increase specific power and reduce the negative effect of CO on membrane electrode (MEA) platinum catalyst activity. Although composite membranes prepared from commercially available spin dope of 14.6 wt % PBO in PPA can produce a membrane support film with outstanding mechanical properties and increased electrochemical performance, still greater electrochemical output is still desirable.

It would be highly desirable to develop an improved solid polymer electrolyte membrane with high resistance to dehydration, high mechanical strength and stability to temperatures of at least about 100° C., more preferably to at least about 120° C. It would also be desirable to develop an improved, high conductivity solid polymer electrolyte membrane that retains high electrical conductivity over a wide range of temperature and relative humidity conditions.

It would also be highly desirable to develop a membrane with the aforementioned characteristics that would be suitable for use in a hydrogen or methanol fuel cell and that would provide an economical option to currently available membranes. The development of such a membrane would promote the use of SPEFCs in a variety of highly diverse military and commercial applications, and would be beneficial to industry and to the environment.

### SUMMARY OF THE INVENTION

The present invention provides innovative solid polymer electrolyte membranes that are capable of operating over a wider range of temperature and pressures (e.g., relative humidities) than those known in the art. Methods for producing such membranes are also provided. The membrane manufacturing technologies developed emphasize improved performance at reduced cost.

In certain aspects, the invention provides a solid polymer electrolyte membrane (SPEM) comprising a co-processed mixture of a substrate polymer and an ion-conducting material, wherein

(i) the substrate polymer comprises a homopolymer or copolymer of a liquid crystalline polymer or a solvent soluble thermoset or thermoplastic aromatic polymer, and

(ii) the ion-conducting material comprises a homopolymer or copolymer of at least one of a sulfonated, sulfonimidated, phosphonated or carboxylated ion-conducting polymer or a perfluorinated ionomer.

Certain other aspects of the invention provide solid polymer electrolyte membranes (SPEM) comprising a blend of a substrate polymer and an ion-conducting material, wherein

(i) the substrate polymer comprises a homopolymer or copolymer of a liquid crystalline polymer or a solvent soluble thermoset or thermoplastic aromatic polymer, and

(ii) the ion-conducting material comprises a homopolymer or copolymer of at least one of a sulfonated, sulfonimidated, phosphonated or carboxylated ion-conducting polymer or a perfluorinated ionomer, wherein the SPEM has a conductivity of at least about 1×10⁻⁴ (S/cm).

In certain other aspects, the invention provides methods of producing the solid polymer electrolyte membrane (SPEM) provided herein. The methods comprise the steps of:
1. preparing a mixture(e.g., a solution) of a substrate polymer and an ion-conducting material in a common solvent;
2. compressing, casting, or extruding the mixture to form a membrane; and
3. coagulating the membrane to generate the SPEM.

The membranes of the present invention are useful in a variety of electrochemical devices, including fuel cells, electronic devices, systems for membrane-based water electrolysis, chloralkali electrolysis, dialysis or electrodialysis, pervaporation or gas separation.

The foregoing and other objects, features and advantages of the invention will become better understood with reference to the following description and appended claims.

### BRIEF DESCRIPTION OF THE DRAWINGS

FIG. 1 is a schematic diagram of an apparatus suitable for homogeneous dilution of as-polymerized solutions of rigid rod and extended rod polymers.

### DETAILED DESCRIPTION OF THE INVENTION INCLUDING PREFERRED EMBODIMENTS

The membranes of the present invention are designed to address the present shortcomings of today's low temperature solid polymer electrolyte membranes, specifically Nafion® (and other like membranes such as Gore-Select®) and high temperature, low RH polymer electrolyte membranes such as the Celanese/Plug Power membranes.

The present invention provides a relatively low cost, solid polymer electrolyte membrane (SPEM), with improved power density, improved operational tolerance to variations in temperature and relative humidity, and reduced sensitivity to carbon monoxide in hydrogen fuel. It may also alleviate water management problems which limit the efficiency of present Nafion® membrane-based fuel cells.

The membranes of the present invention may be employed in various applications, including but not limited to, polarity-based chemical separations; electrolysis; fuel cells and batteries; pervaporation; reverse osmosis—water purification, gas separation; dialysis separation; industrial electrochemistry, such as choralkali production and other electrochemical applications; water splitting and subsequent recovery of acids and bases from waste water solutions; use as a super acid catalyst; use as a medium in enzyme immobilization, for example; or use as an electrode separator in conventional batteries.

The membranes SPEMs of the present invention comprise a coprocessed mixture of a substrate polymer and an ion-conducting material. The coprocessed mixture of the membrane is prepared by forming a membrane from a mixture comprising both the substrate polymer and the ion conducting material. Although not wishing to be bound by theory, Foster-Miller believe that membrane formation from a co-processed mixture of the substrate polymer, the ion-conducting material and a solvent provides a membrane composed of a blend of the substrate polymer and the ion-conducting material, or alternatively the membrane is composed of a substantially uniform admixture of the substrate polymer and the ion-conducting material.

The coprocessed mixture of the substrate polymer and the ion-conducting material may be prepared using any suitable means and any concentration and relative composition of the coprocessed mixture which can be cast, extruded, pressed or otherwise processed to form a membrane SPEM having a coprocessed mixture or blend of substrate polymer and ion-conducting material is contemplated by the instant invention.

In certain preferred embodiments, the coprocessed mixture of the substrate polymer and the ion-conducting material is prepared by diluting a high concentration dope solution of the substrate polymer with a solution of the ion-conducting material to provide an intermediate concentration solution comprising both the substrate polymer and the ion-conducting material. The intermediate concentration solution typically comprises between about 1.5% and about 12% of the substrate polymer by weight and may be in either the nematic or the isotropic phase.

In certain other embodiments, the coprocessed mixture of the substrate polymer and the ion-conducting material is prepared by solvating the substrate polymer and the ion-conducting material in a common solvent. Alternatively, separate previously prepared solutions of the substrate polymer and the ion-conducting material can be combined to provide a mixture of the substrate polymer and the ion-conducting material. Typically coprocessed mixtures of the substrate polymer and the ion-conducting material prepared by dissolving the components in a solvent are in the isotropic phase and have a substrate polymer concentration of less than about 1.5% by weight.

Methods of preparing the SPEMs of the invention are not particularly limited. However due to the challenges associated with processing polybenzazole (PBZ) or polyaramid (PAR) substrate polymers, certain preferred methods of co-processed SPEM formation include (a) processing low concentration solutions prepared by dissolution of the substrate polymer and the ion conducting membrane in a common solvent, and (b) extruding, pressing, or casting a membrane from an intermediate concentration solution prepared by diluting a high concentration dope solution of the substrate polymer with a solution of the ion-conducting material.

The substrate polymer serves as a mechanically, thermally, chemically and oxidatively durable support for the ion-conducting material, e.g., polymer. Ion-conducting polymers (ICPs) with very high ion-exchange capacities (preferably, IEC>0.5 meq/g; more preferably, IEC>1.5 meq/g or >2.5 meq/g; or ICM with an IEEC of between 1.5-11.0 meq/g or between 2.5-11.0 meq/g) can be used in SPEMs of the present invention, since the strength properties of the ICP are not needed for membrane mechanical integrity.

Although not wishing to be bound by theory, the co-processing of the substrate polymer and the polymeric ion-conductive membrane appears to provide a membrane having a desirable morphology in which the substrate polymer and the ion conductive material are distributed more uniformly throughout the membrane than prior solid polymer electrolyte membranes, or possibly the substrate polymer and ion-conductive material are dispersed in the membrane on a molecular level. Moreover, the basic functional groups of the substrate polymer and the acidic functional groups of the ion conductive polymer appear to be more intimately mixed such that proton transport through the membrane is capable of functioning through either a water hopping mechanism when the membrane is hydrated (high relative humidity) or by proton hopping from adjacent deprotonated acid functional groups. Although the exact mechanism may not be known at this time, the co-processed membranes of the invention provide increased electrical conductivity over a wide range of temperature and relative humidity operating conditions as compared to Nafion-based membranes or microporous composite membranes.

Preferably, thermally stable, wholly aromatic polymers are used in producing the membranes of the present invention, but any material(s) meeting the following requirements may generally be used: low cost, high ionic conductivity, electronically insulating, impermeable to fuel(H₂ or methanol) and oxidizer (O₂) at elevated temperatures and pressures in fuel cell applications, chemically resistant to acids and free radicals, resistance to puncture or burst during operation at high temperatures and pressures, and maintenance of ionic conductivity at elevated/high operating temperatures.

The selection criteria for substrate polymers and ion-conducting materials suitable for SPEMs of the present invention are described below. Structures for preferred substrate polymers and ion-conducting polymers are indicated in Tables 4 to 7 of U.S. Pat. No. 6,248,469, which is hereby incorporated by reference.

Preferred substrate polymers are easily synthesized from commercially-available, low-cost starting polymers, into thin, substantially defect free polymeric films which have high strength even at low thickness (preferably less than about 1 mil), outstanding crease/crack resistance and high tear strength. Preferred substrate polymers are substantially chemically resistant to acids, free radicals and solvents (i.e., methanol) and are thermally and hydrolytically stable from temperatures of about 50° C. to 300° C. Preferred substrate polymers possess exceptional mechanical properties (much greater than about 2500 psi tensile, much less than about 100% elongation to break), dimensional stability, barrier properties (to methanol, water vapor, oxygen and hydrogen) even at elevated temperatures and pressures and exceptional gauge uniformity (±0.2 mils preferable). In preferred embodiments, the substrate polymers are thermally and hydrolytically stable to temperatures of at least about 100° C.

In some preferred embodiments of the present invention, the substrate polymer of the SPEM comprises a lyotropic liquid crystalline polymer, such as a polybenzazole (PBZ) or polyaramid (PAR or Kevlar®) polymer. Preferred polybenzazole polymers (PBZ) include polybenzoxazole (PBO), polybenzothiazole (PBZT) and polybenzimidazole (PBI) polymers. Preferred polyaramid polymers include polypara-phenylene terephthalamide (PPTA) polymers. Structures of the above-mentioned polymers are listed in Table 1. Certain preferred polybenzazole substrate polymer comprises an alternating structure comprising an optionally substituted phenyl or naphthyl group and a repeat unit selected from benzoxazole, benzothiazole, diimidazo-pyridine, and benzimidazole.

In other preferred embodiments, the substrate polymer of the SPEM comprises a thermoplastic or thermoset aromatic polymer. Preferred groups of these aromatic polymers include the following: polysulfone (PSU), polyimide (PI), polyphenylene oxide (PPO), polyphenylene sulfoxide (PPSO), polyphenylene sulfide (PPS), polyphenylene sulfide sulfone (PPS/SO₂), polyparaphenylene (PPP), polyphenylquinoxaline (PPQ), polyarylketone (PK) and polyetherketone (PEK) polymers.

Preferred polysulfone polymers include polyethersulfone (PES), polyetherethersulfone (PEES), polyarylsulfone, polyarylethersulfone (PAS), polyphenylsulfone (PPSU) and polyphenylenesulfone (PPSO₂) polymers. Preferred polyimide polymers include the polyetherimide polymers and fluorinated polyimides. Preferred polyetherketone polymers include polyetherketone (PEK), polyetheretherketone (PEEK), polyetherketone-ketone (PEKK), polyetheretherketone-ketone (PEEKK) and polyetherketoneetherketone-ketone (PEKEKK) polymers. The structures of the above polymers are listed in Tables 5 to 6 of U.S. Pat. No. 6,248,469, which is hereby incorporated by reference.

More preferably, the substrate polymer comprises a lyotropic liquid crystal polymer. Most preferably, the substrate polymer comprises a lytotropic liquid crystal poly(bisbenzoxazole)polymer (PBZ), such as a PBO, PBT, or PBI.

The PBZ polymers are members of a class of polymeric materials collectively referred to as ordered polymers. As a result of this rigid rod-like molecular structure, PBZ polymers form liquid crystalline solutions from which extremely strong, stiff fibers and films have been processed. When the PBZ polymers are in a dry (entirely collapsed) form, they have the following characteristics: high strength and dimensional stability, superior barrier (gaseous) properties, excellent crease/crack resistance, excellent tear strength, and superior thermal and hydrolytic temperature stability (>300° C.).

Certain preferred ion-conducting polymers for use in the present invention are easily sulfonated or synthesized from commercially-available, low-cost starting polymers, and are swellable, but highly insoluble in boiling water (100° C.) or aqueous methanol (>50%) over extended time periods. Certain other preferred ion-conducting polymers for use in the present invention are easily sulfonated or synthesized from commercially-available, low-cost sulfonated monomers, and are soluble in water at temperatures between room temperature (e.g., about 10-20° C.) and boiling (e.g., at least 100° C.).

These preferred ion-conducting polymers have limited methanol permeability (limited methanol diffusivity and solubility) even at elevated temperatures and pressures, are substantially chemically stable to acids and free radicals, and thermally/hydrolytically stable to temperatures of at least about 100° C. These same preferred ion-conducting polymers have an ion-exchange capacity (IEC) of >0.5 meq/g dry membrane or greater than 1.5 meq/g (preferably, between 1.5 meq/g or between 11 meq/g) and are highly ion-conducting (preferably, from about 0.01 to about 0.5 S/cm, more preferably, to greater than about 0.1 S/cm or <10Ωcm resistivity). Preferred ion-conducting polymers form miscible blends with the substrate polymer in a common media. Such films are durable, substantially defect-free, and dimensionally stable (less than about 20% change in dimension wet to dry) even above temperatures of at least about 100° C. Preferred ion-conducting polymers have the ability to survive operation in fuel cells (i.e., H₂/O₂, methanol) for at least about 5000 hours (e.g., automotive applications).

In certain aspects, the invention provides a solid polymer electrolyte membrane (SPEM) comprising a co-processed mixture of a substrate polymer and an ion-conducting material, wherein

(i) the substrate polymer comprises a homopolymer or copolymer of a liquid crystalline polymer or a solvent soluble thermoset or thermoplastic aromatic polymer, and

(ii) the ion-conducting material comprises a homopolymer or copolymer of at least one of a sulfonated, sulfonimidated, phosphonated or carboxylated ion-conducting polymer or a perfluorinated ionomer.

Certain other aspects of the invention provide solid polymer electrolyte membranes (SPEM) comprising a blend of a substrate polymer and an ion-conducting material, wherein

(i) the substrate polymer comprises a homopolymer or copolymer of a liquid crystalline polymer or a solvent soluble thermoset or thermoplastic aromatic polymer, and

(ii) the ion-conducting material comprises a homopolymer or copolymer of at least one of a sulfonated, sulfonimidated, phosphonated or carboxylated ion-conducting polymer or a perfluorinated ionomer, wherein the SPEM has a conductivity of at least about 1×10⁻⁴ (S/cm).

Certain preferred solid polymer electrolyte membranes (SPEM) have a conductivity of at least about 1×10⁻⁴ (S/cm) (or more preferably of at least 5×10⁻⁴ (S/cm), 1×10⁻³ (S/cm), 5×10⁻³ (S/cm) or more). More preferably, the SPEMs provided by the invention have a conductivity of at least about 1×10⁻⁴ S/cm at any combination of temperature and relative humidity, wherein the temperature of between about 60° C. and about 200° C., and the relative humidity is between about 0% and about 100%.

Certain other preferred SPEMs provided by the instant invention include those SPEM having a conductivity of at least about 1×10⁻³ (S/cm) (or more preferably of at least 5×10⁻³ (S/cm)) at a temperature of greater than about 60° C. and a relative humidity of between about 25% and 100%. More preferably, the SPEM has a conductivity of at least about 1×10⁻³ (S/cm) (or more preferably of at least 5×10⁻³ (S/cm)) at a temperature of greater than about 80° C. and a relative humidity of between 25 and 100%.

Certain other preferred SPEMs of the invention include those SPEMs that have a conductivity of at least about 1×10⁻⁴ (S/cm) (or more preferably of at least 5×10⁻³ (S/cm)) at a temperature of greater than 60° C. and any relative humidity. Yet other preferred SPEMs of the invention include SPEMs having a conductivity of at least about 1×10⁻⁴ (S/cm) (or more preferably of at least 5×10⁻³ (S/cm))at any combination of temperature and relative humidity conditions of between about 80° C. and about 200° C. and between 0% and 100% relative humidity.

Certain other preferred SPEM provided by the invention have a conductivity of at least 1×10⁻⁴ (S/cm) (or more preferably of at least 5×10⁻³ (S/cm))at a temperature of less than 95° C. and a relative humidity of at least about 50%. Yet other preferred SPEM provided by the invention have a conductivity of 1×10⁻⁴ (S/cm) (or more preferably of at least 5×10⁻³ (S/cm))at a temperature of greater than 110° C. and a relative humidity of less than 50%. More preferably, SPEM provided by the invention possess improved conductivity at both high temperature/low relative humidity and at low temperatures/high relative humidity. That is, certain preferred SPEMs of the invention have a conductivity of at least 1×10⁻³ (S/cm) (or more preferably of at least 5×10⁻³ (S/cm))at a temperature of less than 95° C. and a relative humidity of at least about 50%; and wherein the SPEM has a conductivity of 1×10⁻⁴ (S/cm) (or more preferably of at least 5×10⁻³ (S/cm))at a temperature of greater than 110° C. and a relative humidity of less than 50%.

Yet other preferred SPEMs of the invention have a conductivity of at least 1×10⁻⁴ (S/cm) (or more preferably of at least 5×10⁻³ (S/cm))at a temperature of between about 150° C. and 200° C. under atmospheric pressure.

In SPEMs having a co-processed mixture or blend of the substrate polymer comprising a plurality of basic residues and an ion-conducting material comprising a plurality of acidic residues, the ratio of acid residues to basic residues is between about 10:1 and about 1:10. More preferably the ratio of acid residues to basic residues is between about 8:1 and 1:8, between about 6:1 and 1:6, between about 4:1 and 1:4, between about 3:1 and 1:3 or between about 2:1 and about 1:2. In certain preferred SPEMs of the invention, the ratio of acid residues to basic residues is between about 3:1 and about 1:1.

Yet other preferred SPEM of the invention are stable from at least about 60° C. to at least about 200° C., or from at least about 80° C. to at least about 175° C. Still other preferred SPEM of the invention are stable from at least about 100° C. to at least about 175° C.

The method of formation of the SPEM provided herein is not particularly limited and may include casting, spin coating, extruding, pressing and other membrane formation techniques. Preferred membranes formation techniques which are suitable for preparing SPEMs of the invention include casting, extrusion and pressing. Certain preferred SPEMs of the invention are formed by pressing a dope solution comprising the substrate polymer and the ion-conductive membrane under high pressure to form a film, and coagulating the film to form the SPEM. In certain preferred embodiments, the SPEM are prepared from a co-processed mixture comprising the substrate polymer, the ion-conductive material, and at least one solvent. Typically preferred pressures suitable for pressing the membrane are between about 200 psi and about 2000 psi, or more preferably are between about 500 psi and about 1500 psi. Typically preferred pressures are about 500 psi, about 750 psi, about 1000 psi, about 1250 psi and about 1500 psi.

Certain other preferred SPEM of the invention include those SPEM comprising a membrane formed by casting, pressing under high pressure, or extruding a mixture comprising the substrate polymer, the ion-conductive material, and at least one solvent to form a film, and coagulating the film to form the SPEM.

In certain preferred embodiments, the SPEM of the invention comprises a substrate polymer selected from homopolymers or copolymers of at least one of a substituted or unsubstituted polybenzazole polymer, and an ion-conducting material selected from sulfonated homopolymer or copolymer of at least one of a polysulfone (PSU), polyphenylene sulfoxide (PPSO) and polyphenylene sulfide sulfone (PPS/SO₂) polymer.

Preferred polysulfone ion-conductive materials include polymers comprising at least one of a polyethersulfone (PES) and polyphenylsulfone (PPSU) polymer, or more preferably polysulfone polymers produced by condensation of (4,4′-dihalophenyl)sulfone, sulfonated(4,4′-dihalophenyl)sulfone or a mixture thereof with 4,4′-bisphenolbiphenol, or 4,4′-biphenylbiphenyl-dithiol, 1,4-hydroquinone, 1,4-benzene dithiol, and mixtures thereof, each of which may be optionally sulfonated. Certain preferred polysulfones prepared by condensation include those polymers in which at least about 50% of the (4,4′-dihalophenyl)sulfone monomer is sulfonated at one or more of the 3 and 3′ position. More preferably at least about 60%, 70%, 75%, 80%, 85%, 90%, 95%, or substantially all of the (4,4′-dihalophenyl)sulfone monomer is sulfonated at one or more of the 3 and 3′ position

In certain particularly preferred SPEM provided by the invention, the ion-conducting material is a polysulfone polymer of the formula: 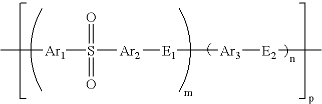
wherein

Ar₁, Ar₂, and Ar₃ are independently selected at each occurrence from carbocyclic aromatic groups having between 6 and 18 carbon ring atoms and between 1 and 3 rings; and at least a portion of the Ar₁, Ar₂, and Ar₃ groups are substituted with sulfonic acid residues;

each occurrence of E₁ and E₂ is independently selected from the group consisting of O, S, and SO₂;

m≧1;

n is an integer of between 0 and about 10; and

p is an integer of between 2 and about 10,000.

Certain other preferred ion-conducting materials for use in the SPEM of the invention include polysulfone polymers of the formula: 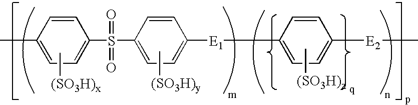
wherein

x, y, and z are integers of between 0 and 4, which are independently selected at each occurrence of x, y or z in the formula, wherein at least a portion of the occurrences of x, y and z is not zero (or more preferably z is zero and at least about 80% of the occurrences of x and y are not zero);

each occurrence of E₁ and E₂ is independently selected from the group consisting of O, S, and SO₂;

m≧1;

n is an integer of between 0 and about 10;

p is an integer of between 2 and about 1,000 (or more preferably p is between about 5 and about 500); and

q is 1, 2, or3.

In one preferred embodiment of the present invention, the ion-conducting material of the SPEM comprises a sulfonated (SO₃H), phosphonated (PO(OH)₂), sulfonimidated (SO₂N(H)SO₂CF₃), or carboxylated (COOH) aromatic polymer. For examples of phosphonates, see Solid State Ionics, 97 (1997), 177-186. For examples of carboxylated solid polymer electrolytes, see Solid State Ionics, 40:41 (1990), 624-627. For examples of sufonimide-based solid polymer electrolytes, see Electrochemical and Solid State Letters, 2(9): (1999), 434-436. For example, the ion-conducting material may comprise a sulfonated derivative of at least one of the above-listed thermoset or thermoplastic aromatic polymers. It may also comprise a sulfonated derivative of a polybenzazole or polyaramid polymer.

Though sulfonated polymers are not readily available in industry, the synthesis of such polymers is well known to the skilled artisan and can be found in various patents and publications. See for example, U.S. Pat. Nos. 4,413,106, 5,013,765, 4,273,903 and 5,438,082, Linkous, et al., J. Polym. Sci., Vol. 86: 1197-1199 (1998), and Wang, et al, J. Memb. Sci., Vol. 197: 231-242 (2002).

In an alternate embodiment, the ion-conducting material of the SPEM of the present invention comprises a non-aromatic polymer, such as a perfluorinated ionomer. Preferred ionomers include carboxylic, phosphonic, sulfonimidic or sulfonic acid substituted substituted perfluorinated vinyl ethers.

Other preferred ion-conducting materials for use in the present invention include polystyrene sulfonic acid (PSSA), polytrifluorostyrene sulfonic acid, polyvinyl phosphonic acid (PVPA), polyvinyl carboxylic acid (PVCA) and polyvinyl sulfonic acid (PVSA) polymers, and metal salts thereof.

More preferably, the ion-conducting material comprises a sulfonated derivative of a polyphenylsulfone (PPSU), polyethersulfone (PES), polyimide (PI), polyphenylene sulfoxide (PPSO) and polyphenylenesulfide-sulfone (PPS/SO₂). These polymers and additional preferred polymers are listed in Table 7 of U.S. Pat. No. 6,248,469, which is incorporated herein by reference.

Compatibilizers may also be employed in producing membranes of the present invention. As used herein, “compatibilizers” refer to agents that aid in the blendability of two or more polymers that would otherwise be resistant to such blending. Examples include block copolymers containing connecting segments of each component. These include both potential substrate and/or ion-conducting polymer components.

In certain applications, it may be desirable to incorporate one or more additives into the co-processed membrane of the SPEM. Typically preferred additives include, but are not limited to, strengthening agents, hardening agents, plasticizers, electroconductive materials, optical modifiers, and the like. Typically the additive is dissolved or suspended in the solution of the substrate polymer and the ion-conductive membrane prior to membrane preparation.

The SPEMs and methods of the present invention will be illustrated by specific combinations of substrate polymers and ion-conducting polymers. However, the present invention should not be construed as being limited in use to any particular substrate polymer or ion-conducting material. Rather, the present teachings are suitable for any substrate polymer and ion-conducting material meeting the criteria set forth herein.

### EXAMPLES OF THE INVENTION

The following procedures were employed in the fabrication and testing of samples that were prepared in accordance with the membranes and methods of this invention.

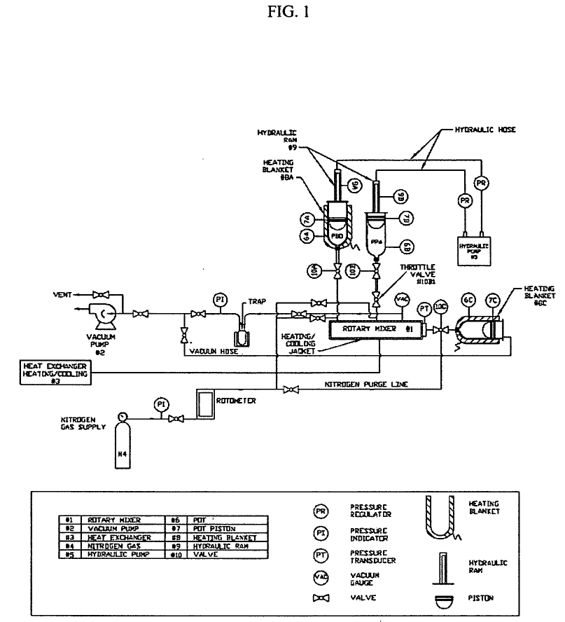

The description of diluting a 14.6% PBO solution in PPA using a high shear mixer (such as a twin screw extruder, a Banbury mixer, a paddle-type co-rotating processor, or shear-generating mixers) is described in reference to the schematic drawing presented in the accompanying drawings, wherein like reference numerals refer to like parts throughout the several views. Referring to FIG. 1, in accordance with the principles of the present invention, there is illustrated a schematic representation of a polymer dope mixing system 100 suitable for use in the dilution methods of the invention. The system includes a high shear mixer 1, a vacuum pump 2, a heat exchange assembly 3, a nitrogen gas supply 4, a hydraulic pump 5, various vessels 6A, 6B, and 6C, which are equipped with pistons 7A, 7B, and 7C, and heating blankets 8A, 8B, 8C, and 8D.

The high shear mixer 1 can be a static batch type mixer such as a Banbury mixer or a rotary paddle type compounding mixer or a continuous feed mixer such as a twin screw extruder or a continuous rotary paddle type mixer.

The vacuum pump 2 is connected to the mixer 1 using appropriate heavy duty vacuum hoses providing sufficient pumping power to maintain extremely low pressures—down to about 100 millitorr—in the mixer to minimize the possibility of gas entrapment in the dope.

A source of nitrogen gas 4 is also plumbed into the system to allow filling of the ullage in the mixer with an inert gas when the mixer is brought up to atmospheric pressure during the discharge of the polymer dope at the conclusion of the mixing cycle.

Both heating and cooling of the mixer are required to properly adjust mixing conditions to minimize time required to achieve complete mixing. This is most easily accomplished using a heat transfer fluid such as mineral oil or water and circulating this fluid from a heat exchanger 3 to a heating/cooling jacket enclosing the mixer.

In the following sections two preferred embodiments are described: The first is the dilution of PBO dope having a nominal concentration as polymerized of 14.6 weight % PBO polymer in PPA to a concentration of 8.0 weight % PBO in PPA. At this concentration the PBO polymer is still in the nematic (ordered phase). The second is the dilution of PBO dope having a nominal as polymerized concentration of 14.6 weight % PBO polymer in PPA to a concentration of 3.0 weight % PBO in PPA. At this lower concentration the PBO polymer is in the isotropic (dis-ordered phase). In certain embodiments, it may be preferable to use membrane SPEMs of the invention prepared from co-process mixtures which are in a nematic or isotropic phase. In certain other embodiments, membrane SPEMs prepared in either the nematic or isotropic phase may be used interchangeably.

### Example 1

### Dilution of 14.6% PBO/PPA Dope to 8.0% PBO/PPA Dope

Referring to FIG. 1, PBO polymer dope is supplied by Toyobo Co., Ltd of Tokyo, Japan as a 14.6 weight % PBO in PPA mixture in stainless steel vessel 6A containing approximately 10 pounds of polymer dope. The vessel 6A has a 1 inch NPT thread at one end and a 5 inch domed piston 7A with two sealing “O” rings to form a gas tight seal within the body of the container. At the chemical plant the polymer dope which is at a temperature of approximately 120° C. is forced under pressure directly from the sealed polymerization process into the 1 inch diameter fill/discharge end of vessel 6A forcing the piston 7A back until the vessel is completely filled (piston 7A is pushed to the top of the vessel 6A/limit of its travel. When completely filled the vessel 6A is then capped at the fill/discharge end with a 1 inch diameter pipe cap to form a gas tight seal. The viscosity of the 14.6% PBO/PPA dope at room temperature is solid or very similar to that of a brick. In order to discharge this extremely viscous material from the vessel 6A it must first be heated to a temperature of 120° C. by an electric heating blanket 8A to reduce the viscosity to a point where it can be pushed out of the vessel 6A by the piston 7A using hydraulic pressure from hydraulic pump 5 acting on hydraulic ram 9A. A pressure of 1500 psi is sufficient to flow the dope out of the vessel into the mixer 1, which is under vacuum. The dope containing vessel 6A is preheated by electric heating blanket #8A for approximately 6 hours prior to the start of the mixing run to insure that the polymer dope is at a uniform temperature of 120° C.

The diluent is prepared in vessel 6B. Polyphosphoric acid, which is used as the diluent, is poured into an empty clean vessel 6B with the piston 7B withdrawn to its maximum length of travel. The PPA is degassed after charging vessel 6B prior to use in the mixing process, in part because PPA often has a significant amount of entrapped air. Degassing is accomplished by heating vessel 6B to 100° C. with an electric heating blanket 8B and pulling a vacuum on the head space of the partially filled vessel. After about 4 hours, vessel 6B contains essentially gas-free PPA, which has a consistency of Karo syrup at room temperature. Once cooled to room temperature the piston 7B is manually pushed up so that the diluent level completely fills the 1 inch diameter discharge/fill pipe on vessel 6B. A 1 inch diameter female stainless steel ball valve 10 in the closed position is affixed to the discharge/fill pipe to form a gas tight seal on diluent vessel 6B.

Vessels 6A and 6B are attached to valves 10A and 10B, which are in fluid contact with mixer 1 as shown in FIG. 1. Hydraulic rams 9A and 9B connected by high pressure hydraulic hoses to hydraulic pump 5 are then mounted on the flanges of vessels 6A and 6B to move the pistons 7A and 7B to assist in feeding the polymer dope and diluent into mixer 1.

Mixer 1 is prepared for use in the dilution method by first turning on the vacuum pump 2 and pulling a vacuum on the mixer chamber to form pressure of about 100 millitorr. Simultaneously, heating jacket 8D warms the mixer 1 to 120° C. The rotating elements of the batch mixer used in this embodiment are rotated at a speed of 30 RPM. Once the temperature, vacuum levels and rotating speed of the mixing elements have stabilized, hydraulic ram 9A on polymer feed vessel 6A is pressurized to 1500 psi by hydraulic pump 5 and feed valve 10A is opened to allow flow of the polymer dope into the mixer 1. As-polymerized dope solution (14.6% PBO/PPA, 2.81 kilograms) was introduced into the mixer 1. After 26 minutes, all of the as-polymerized dope solution was added to the mixer. Feed valve 10A was then closed and hydraulic pressure from pump 5 to hydraulic ram 9A was discontinued. After complete addition of the as-polyrnerized dope, the torque on the rotating shafts of the mixer increased to about 66.9 Nm/Itr and the rotation rate of the shafts decreased from 30 rpm to 18 rpm. After an 14 additional minutes of mixing, “opened” the viscous 14.6% polymer dope solution sufficiently to permit mixing with the low-viscosity diluent.

Piston 7B was pressurized by hydraulic ram 9B by hydraulic pump 5 forty minutes after commencing addition of the as-polymerized dope solution to mixer 1. Pressurizing vessel 7B with only 300 psig was sufficient to transfer the relatively low viscosity diluent (e.g., PPA). Valve 10B was opened and then needle valve 10B1 was opened to allow a flow of diluent into the mixer 1, wherein the rate of addition of diluent to the mixer was 114 g/minute. After 20 minutes, all of the diluent is introduced into the mixer (2.27 kg of diluent (PPA)), and the needle valve 10B1 was closed followed by the closure of on/off valve 10B and hydraulic pressure on piston 7B via ram 9B was discontinued. At the end of the PPA feed the rotating element speed had recovered to its original set point of 30 rpm and the specific torque had decreased to 58.3 Nm/Itr. After an additional 1.5 hours in the mixer, the material was discharged from the mixer through discharge port valve 10C into receiving vessel 6C, which was heated to 60° C. The isolated homogeneous diluted PBO solution recovered from the mixer weighted 3.13 kg and had a PBO loading of about 7.7% by weight relative to PPA.

Intrinsic Viscosity measurements showed that the diluted dope had an Intrinsic Viscosity of 21.3 dL/g as compared to an original Intrinsic Viscosity of 23.0 dL/g for the as received dope indicating that the molecular weight reduction was less than 1%. Subsequent mechanical tests of polymer films produced from this lower concentration dope confirmed this by measuring tensile strengths approximately equal to those of films produced from the 14.6% dope. Mechanical properties of extruded biaxially oriented blown films from both the 14.6% and 7.7% dopes produced under similar process conditions are listed in Table 1 which follows.

TABLE 1
Physical characteristics for biaxially oriented
blown films prepared from dope solutions having
14.6% and 7.7% by weight PBO in PPA.

| | Tensile Strength | | Tensile Modulus | | Viscosity |
|---|---|---|---|---|---|
| Dope | (ksi) | | (ksi) | | dL/g |
| Concentration | MD¹ | TD² | MD¹ | TD² | IV |
| 14.6 | 107.4 | 59.3 | 6222 | 3300 | 23.0 |
| 7.7 | 110.2 | 50.2 | 3568 | 2242 | 21.3 |

¹denotes machine direction;
²denotes transverse direction.

### Example 2

### Dilution of 14.6% PBO/PPA Dope to 3.0% PBO/PPA Dope

An isotropic PBO dope having 3% PBO in PPA by weight was prepared from a 14.6% nematic phase PBO dope using the dilution method and apparatus recited in Example 1 and depicted schematically in FIG. 1.

The amounts of reagents and process times were modified as follows: 14.6% dope (1.06 kg) was introduced over 15 minutes with an additional 10 minutes of mixing to complete opening of the dope prior to addition of the diluent. Polyphosphoric acid (PPA; 2.27 kg) was added at a rate of 114 g/minute and diluted dope was mixed for 1.5 hours after complete addition of the PPA.

The diluted dope was in an isotropic phase and had 3.19% by weight PBO in PPA. The measured intrinsic viscosity was 18.5 indicating less than a 5% reduction in molecular weight during the dilution process.

### Example 3

### SPEM Comprising a Coprocessed Mixture of PBO and PVPA

A SPEM membrane was produced by co-mixing a solution of the lyotropic liquid crystalline polymer and the ion conducting polymer at low concentration in methane sulfonic acid. Thus, a solution of poly(vinyl phosphonic acid) (PVPA) in methane sulfonic acid (MSA) is mixed together with a solution of poly(bisbenzoxazole) (PBO) also in MSA to form a low concentration solution. The ratio of PBO:PVPA repeat units ranges from 1:4 to 1:10. The solution was then cast into a film, and film was coagulated in water or acetone. The resulting film was dried at 175° C. under N₂. The film was then tested for conductivity at 150° C. in dry conditions (low relative humidity; no pressurization) using a four-point conductivity measurement. Elemental analysis was also performed to determine the ratio of PBO:acid in the dried film.

### Example 4

### SPEM Comprising a Coprocessed Mixture of PBO and PSSA

Alternatively, membrane can be produced by co-mixing a solution of the lyotropic liquid crystalline polymer and the ion conducting polymer is a common solvent. This co-mixed solution can be shaped into a membrane, and then coagulated to remove the solvent. Two methods of co-mixing a lyotropic liquid crystalline polymer and an ion conducting polymer (ICP) are described in this example.

A solution of poly(styrene sulfonic acid) (PSSA) and PBO in polyphosphric acid was prepared using the dilution technique recited in Examples 1 and 2, where the PPA diluent is replaced with a PPA solution of PSSA. Thus, a solution of PSSA was prepared in poly(phosphoric acid) (PPA). This solution was then mixed with a 14.6% solution of PBO in PPA using a high shear mixer to form a 7% solution. The resulting dilute solution of PSSA and PBO was shaped into a film by application of high pressure using a hydraulic press. The film was coagulated and dried at 175° C. under N₂. Conductivity testing and elemental analysis was performed as described in Example 3.

### Comparative Example 1

### Microporous Membrane of PBO and PVPA

PEMs were prepared by an imbibing process during which porous unconsolidated PBO membranes were soaked in solutions of PVPA. To imbibe with PVPA, PBO membranes were first tensioned in stainless steel rings. The films were then soaked in solutions of water and 20 wt % PVPA at 80° C. overnight. This allowed the ICP concentration in the membrane pores to reach equilibrium with the bulk solution concentration. The films were pulled out of the imbibing solution and any excess surface ICP was removed. Any desired surface treatment was then performed. Surface treatment could include application of a thin layer of Nafion® by immersion of the PEM in a 2% Nafion/DMAc solution. The samples were dried to 175° C. on a ramp and soak cycle (see below).

PEM Drying Cycle:

1. Ramp (1 deg/min) to 75° C. and soak for 60 minutes

2. Ramp(1 deg/min) to 100° C. and soak for 60 minutes

3. Ramp(1 deg/min) to 150° C. and soak for 60 minutes

4. Ramp(1 deg/min) to 175° C. and soak for 60 minutes

Collapse of the structure upon drying yielded a fully densified PEM.

### Comparative Example 2

### Microporous Membrane of PBO and PSSA

A microporous SPEM composed of microporous composite of PBO and PSSA was prepared according to the method of Comparative Example 1 wherein PSSA was substituted for PVPA.

Conductivity testing and elemental analysis is performed as described above.

The table below shows the chemical and electrochemical data for the films prepared in Examples 3 and 4 and Comparative Examples 1 and 2.

| | PBO/PVPA | | PBO/PSSA | |
|---|---|---|---|---|
| | Imbibed | PBO/PVPA | Imbibed | PBO/PSSA |
| | (Comparative | Co-processed | (Comparative | Co-processed |
| | Example 1) | (Example 3) | Example 2) | (Example 4) |
| Ratio of N:acid | 1:2 | 1:0.67 | 1:2 | 1:0.4 |
| Conductivity (S/cm) | 3.97 × 10⁻⁵ | 3.65 × 10⁻⁴ | 3.33 × 10⁻⁵ | 9.34 × 10⁻³ |

As indicated by the electrochemical data of the preceding Table, the high temperature/low relative humidity conductivity of the SPEM having a co-processed membrane is one to two orders of magnitude higher than in the SPEM having a imbibed composite membrane notwithstanding the lower ion-conducting polymer loading of the SPEM prepared in Examples 3 and 4. The increased conductivity of the co-processed membrane has been observed for ion-conductive polymers of different acidity (Example 4—strong acid (PSSA) compared against Example 3—weaker acid (PVPA)), and for co-processed membranes prepared from low concentration precursor solution (PBO/PVPA in methanesulfonic acid) or a high concentration precursor solution (PBO/PSSA in polyphosphoric acid).

Although the invention has been described including preferred embodiments thereof and using specific terms, such description is for illustrative purposes only, and it is to be understood that changes and variations may be made by those skilled in the art without departing from the spirit or scope of the invention as set forth in the following claims.

1. A solid polymer electrolyte membrane (SPEM) comprising a co-processed mixture of a substrate polymer and an ion-conducting material, wherein
(i) the substrate polymer comprises a homopolymer or copolymer of a liquid crystalline polymer or a solvent soluble thermoset or thermoplastic aromatic polymer, and
(ii) the ion-conducting material comprises a homopolymer or copolymer of at least one of a sulfonated, sulfonimidated, phosphonated or carboxylated ion-conducting polymer or a perfluorinated ionomer.

2. The SPEM of claim 1, wherein the SPEM has a conductivity of at least about 1×10⁻⁴ (S/cm).

3. The SPEM of claim 1, wherein the SPEM has a conductivity of at least about 1×10⁻⁴ S/cm at any combination of temperature and relative humidity, wherein the temperature of between about 60° C. and about 200° C., and the relative humidity is between about 0% and about 100%.

4. A solid polymer electrolyte membrane (SPEM) comprising a blend of a substrate polymer and an ion-conducting material, wherein
(i) the substrate polymer comprises a homopolymer or copolymer of a liquid crystalline polymer or a solvent soluble thermoset or thermoplastic aromatic polymer, and
(ii) the ion-conducting material comprises a homopolymer or copolymer of at least one of a sulfonated, sulfonimidated, phosphonated or carboxylated ion-conducting polymer or a perfluorinated ionomer, wherein the SPEM has a conductivity of at least about 1×10⁻⁴ (S/cm).

5. The SPEM of claim 1, wherein the SPEM has a conductivity of at least about 1×10⁻³ (S/cm) at a temperature of greater than about 60° C. and a relative humidity of between about 25% and 100%.

6-13. (canceled)

14. The SPEM of claim 1, wherein the molar ratio of substrate polymer basic residues to ion conducting polymer acidic residues is between about 3:1 and about 1:3.

15. The SPEM of claim 1, wherein the SPEM is stable from at least about 60° C. to at least about 200° C.

16-20. (canceled)

21. The SPEM of claim 1, wherein the liquid crystalline substrate polymer comprises a lyotropic liquid crystalline polymer.

22. The SPEM of claim 21, wherein the lyotropic liquid crystalline substrate polymer comprises at least one of a polybenzazole (PBZ) and polyaramid (PAR) polymer.

23. The SPEM of claim 22, wherein the polybenzazole substrate polymer comprises a homopolymer or copolymer of at least one of a polybenzoxazole (PBO), polybenzothiazole (PBZT) and polybenzimidazole (PBI) polymer and the polyaramid polymer comprises a homopolymer or copolymer of a poly(para-phenylene terephthalamide) (PPTA) polymer.

24-25. (canceled)

26. The SPEM of claim 1, wherein the ion-conductive material is uniformly dispersed in the substrate polymer.

27. (canceled)

28. The SPEM of claim 1, wherein the ion-conducting material has an ion-conductivity greater than about 0.01 S/cm.

29-30. (canceled)

31. The SPEM of claim 1, wherein the ion-conducting material has an ion-exchange capacity greater than about 0.5 milliequivalents per gram.

32-34. (canceled)

35. The SPEM of claim 1, wherein the SPEM has an area specific resistance from about 0.02 to about 20 Ω·cm².

36. (canceled)

37. The SPEM of claim 1, wherein the ion-conducting aromatic polymer comprises wholly aromatic ion-conducting polymer.

38-41. (canceled)

42. The SPEM of claim 1, wherein the substrate polymer comprises a homopolymer or copolymer of at least one of a substituted or unsubstituted polybenzazole polymer, and wherein the ion-conducting material comprises a sulfonated derivative of a homopolymer or copolymer of at least one of a polysulfone (PSU), polyphenylene sulfoxide (PPSO) and polyphenylene sulfide sulfone (PPS/SO₂) polymer.

43-48. (canceled)

49. The SPEM of claim 42, wherein the polysulfone polymer is a compound of the formula: 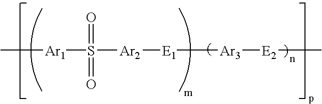
wherein
Ar₁, Ar₂, and Ar₃ are independently selected at each occurrence from carbocyclic aromatic groups having between 6 and 18 carbon ring atoms and between 1 and 3 rings; and
at least a portion of the Ar₁, Ar₂, and Ar₃ groups are substituted with sulfonic acid residues;
each occurrence of E₁ and E₂ is independently selected from the group consisting of O, S, and SO₂;
m≧1;
n is an integer of between 0 and about 10; and
p is an integer of between 2 and about 10,000.

50. The SPEM of claim 49, wherein the polysulfone polymer is a compound of the formula: 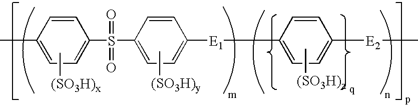
wherein
x, y, and z are integers of between 0 and 4, which are independently selected at each occurrence of x, y or z in the formula, wherein at least a portion of the occurrences of x, y and z is not zero;
each occurrence of E₁ and E₂ is independently selected from the group consisting of O, S, and SO₂;
m≧1;
n is an integer of between 0 and about 10;
p is an integer of between 2 and about 1,000; and
q is 1, 2, or3.

51-52. (canceled)

53. A method of producing a solid polymer electrolyte membrane (SPEM) in accordance with claim 1, comprising the steps of
preparing a mixture of a substrate polymer and an ion-conducting material in a common solvent;
compressing, casting, or extruding the mixture to form a membrane; and
coagulating the composite membrane to generate the SPEM.

54. The method of claim 53, wherein the mixture of the substrate polymer and the ion-conducting material in a common solvent is prepared by diluting a high concentration dope solution of the substrate polymer with a solution of the ion-conducting material.

55. The method of claim 53, wherein the mixture of the substrate polymer and the ion-conducting material in a common solvent is a low concentration solution prepared by dissolving the substrate polymer and the ion-conducting material in a common solvent.

56. A device comprising a composite solid polymer electrolyte membrane in accordance with claim 1.

57. The device of claim 56, wherein the device is a fuel cell.

58-61. (canceled)

62. The SPEM of claim 4, wherein the SPEM has a conductivity of at least about 1×10⁻³ (S/cm) at a temperature of greater than about 60° C. and a relative humidity of between about 25% and 100%.

63. The SPEM of claim 4, wherein the molar ratio of substrate polymer basic residues to ion conducting polymer acidic residues is between about 3:1 and about 1:3.

64. The SPEM of claim 4, wherein the SPEM is stable from at least about 60° C. to at least about 200° C.

65. The SPEM of claim 4, wherein the liquid crystalline substrate polymer comprises a lyotropic liquid crystalline polymer.

66. The SPEM of claim 65, wherein the lyotropic liquid crystalline substrate polymer comprises at least one of a polybenzazole (PBZ) and polyaramid (PAR) polymer.

67. The SPEM of claim 66, wherein the polybenzazole substrate polymer comprises a homopolymer or copolymer of at least one of a polybenzoxazole (PBO), polybenzothiazole (PBZT) and polybenzimidazole (PBI) polymer and the polyaramid polymer comprises a homopolymer or copolymer of a poly(para-phenylene terephthalamide) (PPTA) polymer.

68. The SPEM of claim 4, wherein the ion-conductive material is uniformly dispersed in the substrate polymer.

69. The SPEM of claim 4, wherein the ion-conducting material has an ion-conductivity greater than about 0.01 S/cm.

70. The SPEM of claim 4, wherein the ion-conducting material has an ion-exchange capacity greater than about 0.5 milliequivalents per gram.

71. The SPEM of claim 4, wherein the SPEM has an area specific resistance from about 0.02 to about 20 Ω·cm².

72. The SPEM of claim 4, wherein the ion-conducting aromatic polymer comprises wholly aromatic ion-conducting polymer.

73. The SPEM of claim 4, wherein the substrate polymer comprises a homopolymer or copolymer of at least one of a substituted or unsubstituted polybenzazole polymer, and wherein the ion-conducting material comprises a sulfonated derivative of a homopolymer or copolymer of at least one of a polysulfone (PSU), polyphenylene sulfoxide (PPSO) and polyphenylene sulfide sulfone (PPS/SO₂) polymer.

74. The SPEM of claim 73, wherein the polysulfone polymer is a compound of the formula: 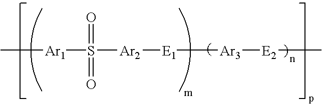
wherein
Ar₁, Ar₂, and Ar₃ are independently selected at each occurrence from carbocyclic aromatic groups having between 6 and 18 carbon ring atoms and between 1 and 3 rings; and
at least a portion of the Ar₁, Ar₂, and Ar₃ groups are substituted with sulfonic acid residues;
each occurrence of E₁ and E₂ is independently selected from the group consisting of O, S, and SO₂;
m≧1;
n is an integer of between 0 and about 10; and
p is an integer of between 2 and about 10,000.

75. The SPEM of claim 74, wherein the polysulfone polymer is a compound of the formula: 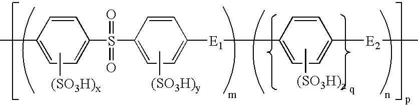
wherein
x, y, and z are integers of between 0 and 4, which are independently selected at each occurrence of x, y or z in the formula, wherein at least a portion of the occurrences of x, y and z is not zero;
each occurrence of E₁ and E₂ is independently selected from the group consisting of O, S, and SO₂;
m≧1;
n is an integer of between 0 and about 10;
p is an integer of between 2 and about 1,000; and
q is 1, 2, or3.

76. A method of producing a solid polymer electrolyte membrane (SPEM) in accordance with claim 4, comprising the steps of
preparing a mixture of a substrate polymer and an ion-conducting material in a common solvent;
compressing, casting, or extruding the mixture to form a membrane; and
coagulating the composite membrane to generate the SPEM.

77. The method of claim 76, wherein the mixture of the substrate polymer and the ion-conducting material in a common solvent is prepared by diluting a high concentration dope solution of the substrate polymer with a solution of the ion-conducting material.

78. The method of claim 76, wherein the mixture of the substrate polymer and the ion-conducting material in a common solvent is a low concentration solution prepared by dissolving the substrate polymer and the ion-conducting material in a common solvent.

79. A device comprising a composite solid polymer electrolyte membrane in accordance with claim 4.

80. The device of claim 79, wherein the device is a fuel cell.
